(19) United States
(12) Patent Application Publication
(10) Pub. No.: US 2022/0252396 A1
(43) Pub. Date: Aug. 11, 2022

(54) THREE-DIMENSIONAL POSITION MEASURING SYSTEM, MEASURING METHOD, AND MEASURING MARKER

(71) Applicant: TOPCON CORPORATION, Tokyo (JP)

(72) Inventor: Takeshi KIKUCHI, Tokyo (JP)

(21) Appl. No.: 17/581,308

(22) Filed: Jan. 21, 2022

(30) Foreign Application Priority Data
Feb. 8, 2021 (JP) 2021-017936

(51) Int. Cl. G01C 15/00; G01C 11/02; G01S 17/86; G01S 17/89; G01S 17/42; G01P 15/18

(52) U.S. Cl. CPC G01C 15/002; G01C 11/02; G01P 15/18; G01S 17/89; G01S 17/42; G01S 17/86

(57) ABSTRACT

A three-dimensional position measuring system includes a surveying instrument including a distance-measuring section, an imaging section, an angle-measuring section, a drive section configured to drive the distance-measuring section to set angles, and a communication section, and a measuring marker including a position sensor, a posture sensor, a laser emitting section configured to emit laser light of visible light in an axial direction, an emission port for the laser light, and a communication section, wherein the measuring marker calculates position information and posture information of the emission port from the position sensor and the posture sensor and transmits the information to the surveying instrument, and the surveying instrument measures a three-dimensional position of the emission port, grasps the axial direction based on the posture information and searches for a measurement point in the axial direction by the imaging section, and measures a three-dimensional position of the measurement point.

### TECHNICAL FIELD

The present invention relates to a measuring system, a measuring method, and a measuring marker for measuring a three-dimensional position of a measurement point.

### BACKGROUND ART

In a survey, by using a surveying instrument that performs a distance measuring and an angle measuring, and a retroreflective prism, a three-dimensional position of a measurement point is measured. However, due to a necessary size of the prism, it is not possible to set an optical reflection point of the prism at the measurement point. Therefore, generally, a method is used in which a measurement point is pointed out with a pointing rod to which the prism is fixed, and a measurement point offset by a fixation length in a direction to the pointing rod from the prism is measured. For example, Patent Literature 1 discloses a system in which by using a measuring module including an omnidirectional camera on a pointing rod to which the prism is fixed, a three-dimensional position of a measurement point is automatically measured by grasping a posture of the measuring module and grasping an offset direction regardless of what posture the measuring module is in.

### CITATION LIST

### Patent Literature

Patent Literature 1: Japanese Published Unexamined Patent Application No. 2018-009957

### SUMMARY OF INVENTION

### Technical Problem

However, in the system disclosed in Patent Literature 1, to know the offset direction, the surveying instrument must always track the prism. Tracking of the prism places a heavy load on an arithmetic section of the surveying instrument, and poses a problem in which when the prism is hidden by an obstacle during tracking, a measurement cannot be performed.

The present invention has been made to solve the problem described above, and an object thereof is to provide, in a measurement of a three-dimensional position of a measurement point, a measuring system, a measuring method, and a measuring marker for the three-dimensional position without requiring tracking of a prism.

### Solution to Problem

In order to solve the problem described above, a three-dimensional position measuring system according to an aspect of the present invention includes a surveying instrument including a distance-measuring section configured to perform a reflection prism distance measuring and a non-prism distance measuring by distance-measuring light, an imaging section configured to perform imaging in an optical axis direction of the distance-measuring light, an angle-measuring section configured to measure a vertical angle and a horizontal angle at which the distance-measuring section is oriented, a drive section configured to drive the vertical angle and the horizontal angle of the distance-measuring section to set angles, and a communication section, and a measuring marker including a position sensor, a posture sensor, a laser emitting section configured to emit laser light of visible light in an axial direction, an emission port for the laser light, and a communication section, wherein the measuring marker calculates position information and posture information of the emission port from the position sensor and the posture sensor and transmits the information to the surveying instrument, and the surveying instrument measures a three-dimensional position of the emission port by the distance-measuring section and the angle-measuring section, grasps the axial direction based on the posture information and searches for a measurement point in the axial direction by the imaging section, and measures a three-dimensional position of the measurement point by the distance-measuring section and the angle-measuring section.

In the aspect described above, it is also preferable that the surveying instrument sets a plurality of object points in the axial direction, images the object points in order from the emission port side by the imaging section, analyzes whether an image of the laser light is included in the imaged images, determines an object point right before an object point where the image of the laser light disappears, as the measurement point, and measures the three-dimensional position.

In the aspect described above, it is also preferable that the measuring marker further includes a distance meter, and the distance meter measures a marker distance from the emission port to the measurement point and transmits the marker distance to the surveying instrument, and based on information on the marker distance, the surveying instrument determines an estimated position offset by the marker distance in the axial direction from the three-dimensional position of the emission port as the measurement point and images the estimated position and several points before and after the estimated position in the axial direction by the imaging section, analyzes whether an image of the laser light is included in imaged images, determines an object point right before an object point where the image of the laser light disappears, as the measurement point, and measures the three-dimensional position.

In the aspect described above, it is also preferable that the measuring marker further includes an emission change button, and the emission change button changes emission of the laser light so that the emission of the laser light is at least changed to flashing emission, changed in light color, or changed in pattern shape.

In the aspect described above, it is also preferable that the measuring marker further includes an adjust button, and the adjust button adjusts the vertical angle and the horizontal angle of the distance-measuring section by operating the drive section.

In the aspect described above, it is also preferable that the surveying instrument includes a guide matching the optical axis direction of the distance-measuring light, the surveying instrument and the measuring marker include mutual engagement portions, the surveying instrument and the measuring marker are synchronized in posture by disposing the measuring marker on the guide, and synchronized in position by engaging the engagement portions with each other.

In order to solve the problem described above, a three-dimensional position measuring method according to an aspect of the present invention includes a surveying instrument and a measuring marker, and includes (a) a step of transmitting position information and posture information of an emission port for laser light to be emitted in an axial direction of the measuring marker to the surveying instrument, (b) a step of emitting distance-measuring light from the surveying instrument and measuring a three-dimensional position of the emission port, (c) a step of imaging a plurality of object points in the axial direction of the measuring marker in order from the emission port side by an imaging section of the surveying instrument, and analyzing whether an image of the laser light is included in imaged images, (d) a step of determining an object point right before an object point where the image of the laser light disappears, as a measurement point, and (e) a step of emitting distance-measuring light from the surveying instrument and measuring a three-dimensional position of the measurement point.

In order to solve the problem described above, a measuring marker according to an aspect of the present invention includes a stick body, a position sensor, a posture sensor, a laser emitting section configured to emit laser light of visible light in an axial direction of the stick body, an emission port for the laser light, a communication section, an arithmetic control section, and a storage section, wherein in the storage section, positional relationships of the position sensor and the posture sensor with the emission port are stored, and the arithmetic control section corrects position information from the position sensor and posture information from the posture sensor by using the positional relationships to calculate position information and posture information of the emission port, and transmits the information from the communication section to the surveying instrument.

### Advantageous Effect of Invention

According to the present invention, a technology for measuring a three-dimensional position of a measurement point without tracking a prism can be provided.

### BRIEF DESCRIPTION OF THE DRAWINGS

FIG. 1 is an external perspective view of a measuring system according to a first embodiment.

FIG. 2 is a configuration block diagram of a surveying instrument according to the first embodiment.

FIG. 3 is a perspective view of a measuring marker according to the first embodiment.

FIG. 4 is a configuration block diagram of the measuring marker according to the first embodiment.

FIG. 5 is a flowchart of a three-dimensional position measuring method according to the first embodiment.

FIG. 6 is a detailed flowchart of measurement in FIG. 5.

FIG. 7 is a work image view of FIG. 6.

FIG. 8A is an image view of a certain object point.

FIG. 8B is an image view of another object point.

FIG. 9 is a detailed flowchart of measurement of a three-dimensional position measuring method according to a second embodiment.

FIG. 10 is a work image view of FIG. 9.

FIG. 11 is a perspective view of a measuring marker according to Modification 1.

FIG. 12 is a perspective view of a measuring marker according to Modification 2.

FIG. 13 is a perspective view of a part of a measuring system according to Modification 3.

### DESCRIPTION OF EMBODIMENTS

Next, preferred embodiments of the present invention will be described with reference to the drawings. In the following description of the embodiments, the same components are provided with the same reference sign, and the same description will be omitted.

### 1. First Embodiment

1-1. Configuration of Measuring System

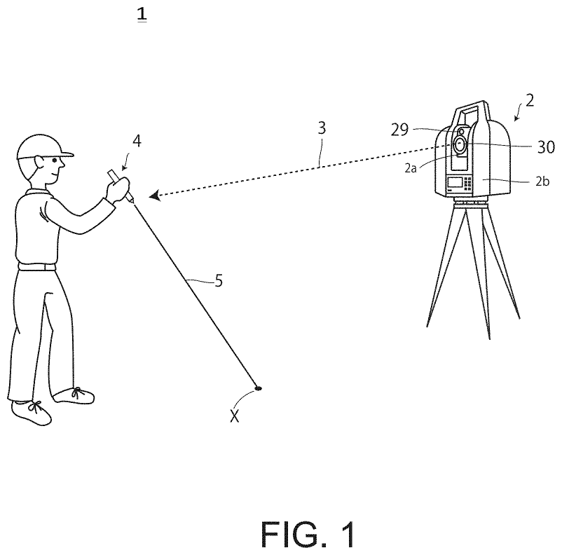

FIG. 1 is an external perspective view of a measuring system according to a first embodiment of the present invention. The reference sign 1 denotes a three-dimensional position measuring system (hereinafter, simply referred to as a measuring system) according to the present embodiment. The measuring system 1 includes a surveying instrument 2 and a measuring marker 4.

In the measuring system 1, the surveying instrument 2 is installed at a known point by using a tripod, and includes, in order from the lower side, a leveling section, a base portion provided on the leveling section, a bracket portion 2b that rotates horizontally on the base portion, and a telescope 2a that rotates vertically at a center of the bracket portion 2b. The surveying instrument 2 emits distance-measuring light 3 to a set object point. The measuring marker 4 is carried by a worker, and used near a measurement point X. The measuring marker 4 emits laser light 5 to point out the measurement point X.

1-2. Configuration of Surveying Instrument

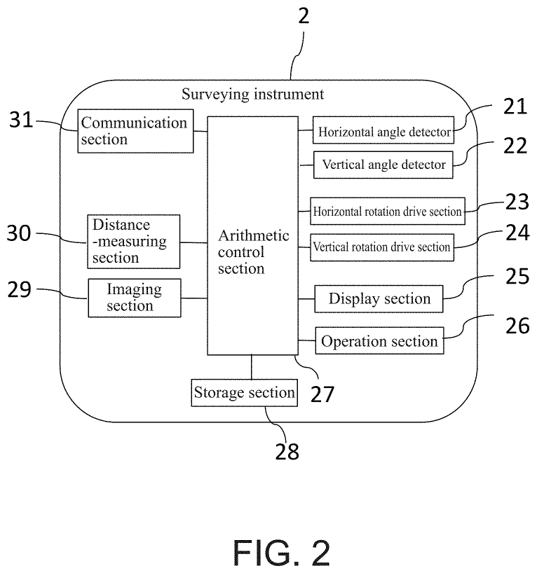

FIG. 2 is a configuration block diagram of the surveying instrument 2 according to the first embodiment. The surveying instrument 2 is a motor-driven total station, and includes a horizontal angle detector 21, a vertical angle detector 22, a horizontal rotation drive section 23, a vertical rotation drive section 24, a display section 25, an operation section 26, an arithmetic control section 27, a storage section 28, an imaging section 29, a distance-measuring section 30, and a communication section 31. The horizontal angle detector 21, the vertical angle detector 22, the horizontal rotation drive section 23, the vertical rotation drive section 24, the arithmetic control section 27, the storage section 28, and the communication section 31 are housed in the bracket portion 2b, and the distance-measuring section 30 and the imaging section 29 are housed in the telescope 2a. However, the display section 25 and the operation section 26 are conventional measuring interfaces for the surveying instrument 2, and are optional elements in the present embodiment.

The horizontal angle detector 21 and the vertical angle detector 22 are encoders. The horizontal angle detector 21 is provided on a rotary shaft of the bracket portion 2b, and detects a horizontal angle of the bracket portion 2b. The vertical angle detector 22 is provided on a rotary shaft of the telescope 2a, and detects a vertical angle of the telescope 2a (the detectors 21 and 22 are the “angle-measuring section” in the claims).

The horizontal rotation drive section 23 and the vertical rotation drive section 24 are motors, and are controlled by the arithmetic control section 27. The horizontal rotation drive section 23 drives the rotary shaft of the bracket portion 2b to a set angle (set horizontal angle), and the vertical rotation drive section 24 drives the rotary shaft of the telescope 2a to a set angle (set vertical angle) (the drive sections 23 and 24 are the “drive section” in the claims). By collaboration of the horizontal rotation of the bracket portion 2b and the vertical rotation of the telescope 2a, the orientation of the distance-measuring section 30 is changed, and distance-measuring light 3 is emitted to a position of a set object point.

The distance-measuring section 30 includes a light transmitting section and a light receiving section, emits distance-measuring light 3, for example, infrared pulsed laser or the like from the light transmitting section, receives reflected light of the distance-measuring light 3 by the light receiving section, and measures a distance from a phase difference between the distance-measuring light 3 and internal reference light. The distance-measuring section 30 can perform both of a reflection prism distance measuring in which a distance to a prism is measured by reflecting the distance-measuring light 3 by the prism, and a non-prism distance measuring in which an object point other than the prism is irradiated with the distance-measuring light 3 to measure a distance to the object point.

The imaging section 29 is an image sensor (for example, a CCD sensor or a CMOS sensor). The imaging section 29 sets an optical axis of the distance-measuring light 3 of the distance-measuring section 30 as an origin and can perform imaging with a wide angle in the up-down direction and the left-right direction with respect to the origin, and images a region including the set object point.

The communication section 31 can wirelessly communicate with a communication section 41 (described later) of the measuring marker 4, and receives information from the communication section 41. For the communication, Bluetooth (registered trademark), various wireless LAN standards, infrared communication, mobile phone line, and other wireless lines, etc., can be used.

The arithmetic control section 27 includes a CPU (Central Processing Unit), and as arithmetic controls, performs information reception by the communication section 31, control of the respective rotary shafts by the drive sections 23 and 24, an angle measuring by the detectors 21 and 22, a distance measuring by the distance-measuring section 30, and analysis of images in the imaging section 29 described later.

The storage section 28 includes a ROM (Read Only Memory) and a RAM (Random Access Memory). In the ROM, programs for the arithmetic controls described above are stored, and each processing is executed by being read by the RAM. Three-dimensional position data measured by the surveying instrument 2 is recorded in the ROM or a recording area described later.

1-3. Configuration of Measuring Marker

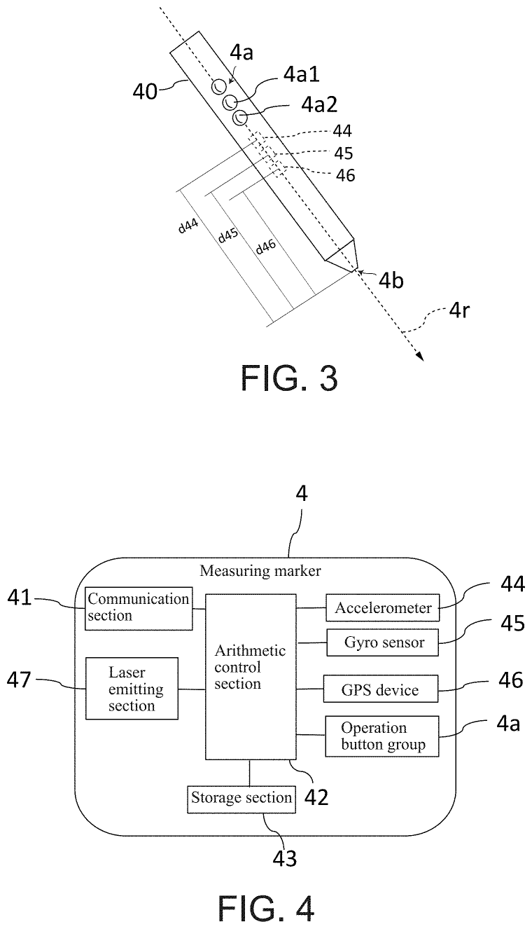

FIG. 3 is a perspective view of the measuring marker 4 according to the first embodiment. The measuring marker 4 includes a stick body 40 having a length that a worker can hold by hand and handle, and includes a button group 4a and an emission port 4b for laser light 5 at a tip end of the body. The operation button group 4a includes at least an emission button 4a1 and a measuring button 4a2.

FIG. 4 is a configuration block diagram of the measuring marker 4 according to the first embodiment. The measuring marker 4 includes a communication section 41, an arithmetic control section 42, a storage section 43, an accelerometer 44, a gyro sensor 45, a GPS device 46, a laser emitting section 47, and the operation button group 4a. The elements 41, 42, 43, 44, 45, 46, and 47 are configured by using a dedicated module and IC configured by using integrated-circuit technology, and housed compactly in the stick body 40.

The accelerometer 44 detects accelerations in three-axis directions of the measuring marker 4. The gyro sensor 45 detects rotations around three axes of the measuring marker 4. The accelerometer 44 and the gyro sensor 45 are the “posture sensors” of the measuring marker 4 in the claims.

The GPS device 46 detects a position of the measuring marker 4 based on a signal from a GPS (Global Positioning System). The GPS device 46 is the “position sensor” of the measuring marker 4 in the claims. The GPS device 46 may use positioning information obtained by a GNSS (Global Navigation Satellite System), a quasi-zenith satellite system, GALILEO, or GLONAS.

The laser emitting section 47 includes a light source and an emission control IC for the light source, and linearly emits laser light 5 in visible color in an axial direction of the stick body 40 of the measuring marker 4 (hereinafter, the direction is identified as a direction toward the emission port 4b and referred to as a marker axial direction 4r. The marker axial direction 4r is the “axial direction” in the claims).

The communication section 41 has at least the same communication standards as those of the communication section 31 of the surveying instrument 2, and transmits information to the communication section 31.

The arithmetic control section 42 includes a CPU, and as arithmetic controls, performs emission of laser light 5, information detection from the posture sensor and the position sensor, information transmission by the communication section 41, and calculation of posture information and position information of the emission port 4b described later. The storage section 43 includes a ROM and a RAM, and enables each processing of the arithmetic control section 42.

Here, inside the stick body 40 of the measuring marker 4, the accelerometer 44, the gyro sensor 45, and the GPS device 46 are disposed on the marker axial direction 4r, and positional relationships of these with the emission port 4b (separating distances d44, d45, and d46 from the emission port 4b) are measured and stored in advance in the storage section 43. However, when the positional relationships with the marker axis 4r are measured and recorded in advance, the accelerometer 44, the gyro sensor 45, and the GPS device 46 may be displaced away from the marker axial direction 4r.

1-4. Measuring Method

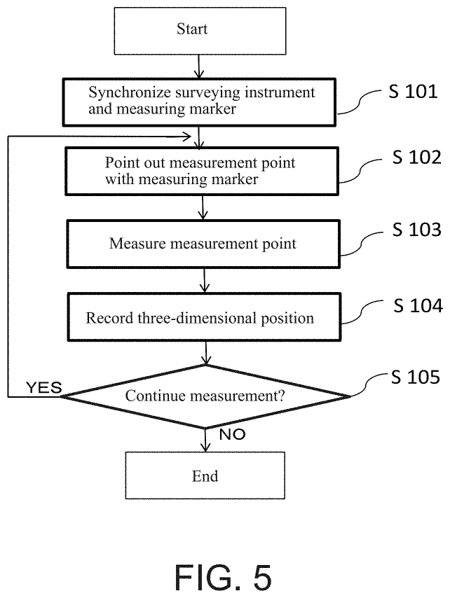

Next, a three-dimensional position measuring method for a measurement point X by using the measuring system 1 will be described. FIG. 5 is a flowchart of the three-dimensional position measuring method according to the first embodiment of the present invention.

When the measurement in the present embodiment is started, first, in Step S101, a worker synchronizes the surveying instrument 2 and the measuring marker 4. For synchronization, the measuring marker 4 is brought closer to the surveying instrument 2 and coordinates of the measuring marker 4 are matched with coordinates of the surveying instrument 2 (positional matching), emitting directions of the distance-measuring light 3 of the surveying instrument 2 and the laser light 5 of the measuring marker 4 are matched with each other, and the posture of the measuring marker 4 is aligned with a reference direction of the surveying instrument 2 (angle matching). After the synchronization, the surveying instrument 2 and the measuring marker 4 start to communicate, and the surveying instrument 2 always grasps the position and the posture of the measuring marker 4.

Next, in Step S102, the worker carries the measuring marker 4 with him/her and moves to a point (measurement point X) that the worker wants to measure. Then, the worker presses the emission button 4a1 and points out the measurement point X with laser light 5.

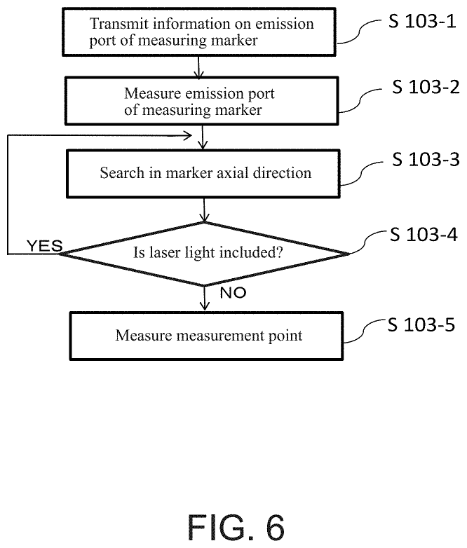

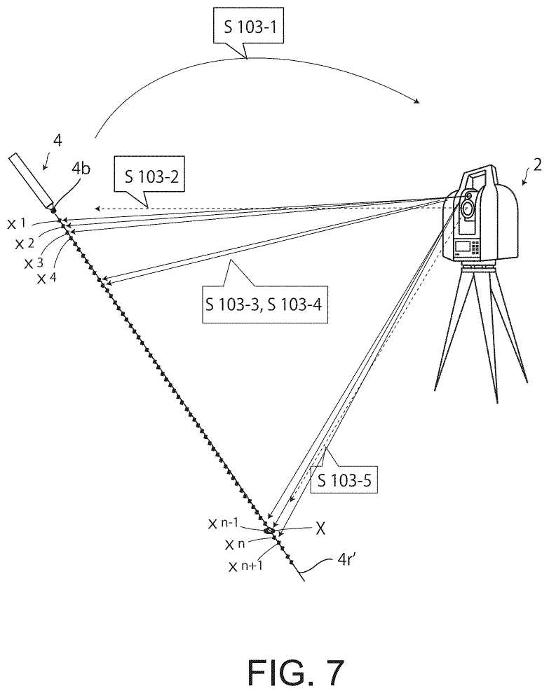

Next, in Step S103, when the worker presses the measuring button 4a2, a three-dimensional position of the measurement point X is automatically measured. The measurement of the three-dimensional position of the measurement point X is performed with the image of tracing on the laser light 5 of the measuring marker 4 by the surveying instrument 2. Details of the measurement will be described with reference to FIGS. 6 and 7. FIG. 6 is a flowchart of details of the measurement in FIG. 5, and FIG. 7 is a work image view of FIG. 6.

When the measuring button 4a2 is pressed in Step S103 in FIG. 5, the processing shifts to Step S103-1 of FIG. 6. The measuring marker 4 acquires posture information and position information of the measuring marker 4 from the accelerometer 44, the gyro sensor 45, and the GPS device 46, calculates posture information of the emission port 4b from the accelerometer 44 and the gyro sensor 45, and calculates position information of the emission port 4b by offsetting position information of the GPS device 46 by the separating distance 46d in the marker axial direction 4r. Then, the measuring marker 4 transmits the posture information and the position information of the emission port 4b to the surveying instrument 2.

Next, in Step S103-2, the surveying instrument 2 measures a three-dimensional position (three-dimensional coordinates) of the emission port 4b by performing a non-prism distance measuring by setting the emission port 4b as an object point based on the posture information and position information of the emission port 4b.

Next, in Step S103-3, based on the posture information of the emission port 4b, the surveying instrument 2 grasps the marker axial direction 4r in a coordinate system of the surveying instrument 2, and sets a plurality of object points on the marker axial direction 4r and searches for the measurement point X.

The measurement point X is searched for by analyzing images captured by the imaging section 29. For example, as illustrated in FIG. 7, it is assumed that the surveying instrument 2 sets object points x1, x2, . . . , xn−1, xn, xn+1, . . . in order from the emission port 4b on a real space (virtual line 4r′) in the marker axial direction 4r. Object point measuring intervals (setting intervals) may be set to even intervals not in a space viewed from the surveying instrument 2 but in a real space (on virtual line 4r′) in the marker axial direction 4r, or when it is desired to perform search in a quick way, may be set to uneven intervals so that the measuring intervals become narrower with the decreasing distance from the measurement point X on the virtual line 4r′. The arithmetic control section 27 of the surveying instrument 2 controls the horizontal rotation drive section 23 and the vertical rotation drive section 24 to align the horizontal angle and the vertical angle of the distance-measuring section 30 with the object points x1, x2 . . . in order, and images the object points by the imaging section 29.

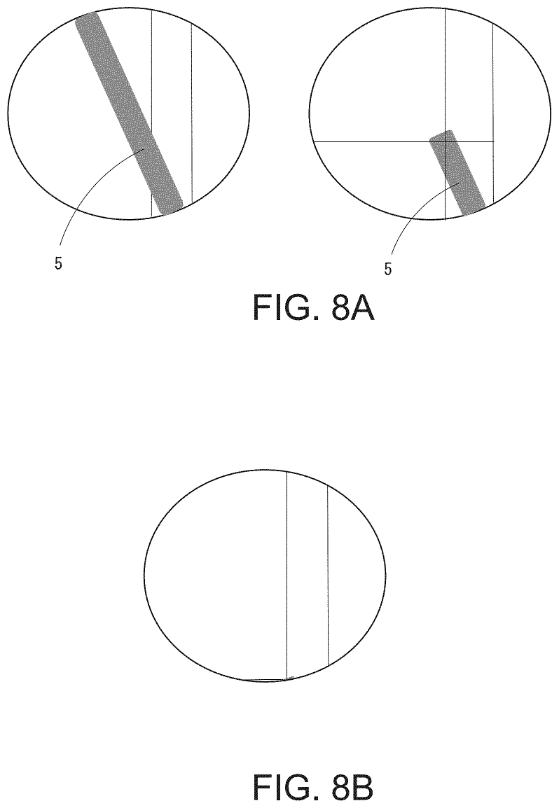

Next, in Step S103-4, the arithmetic control section 27 analyzes whether an image of the laser light 5 is included in images of the object points. For example, when an image of the laser light 5 is included in the image of the object point x3 as illustrated in FIG. 8A (YES), this means that the surveying instrument 2 has not yet reached the measurement point X, so that processing of searching returns to Step S103-3 and shifts to the next object point x4. As long as the image of the laser light 5 is included, the arithmetic control section 27 continues this searching for x5, x6 . . . .

On the other hand, as an example, it is assumed that the image of the laser light 5 has disappeared at the object point xn as illustrated in FIG. 8B. When no image of the laser light 5 is included (NO), this means that the surveying instrument 2 has passed over the measurement point X, so that the processing of searching shifts to Step S103-5, and the arithmetic control section 27 determines the object point xn−1 right before the object point xn as the measurement point X, and performs a non-prism distance measuring for the measurement point X (object point xn−1) to measure a three-dimensional position (three-dimensional coordinates) of the measurement point X. In Step S103 of FIG. 5, a three-dimensional position of the measurement point X is measured in this way.

After the measurement point X is measured, the processing shifts to Step S104 in FIG. 5, and the measured three-dimensional position data of the measurement point X is recorded. The recording area for the three-dimensional position data is not limited to the surveying instrument 2, and the three-dimensional position data may be transmitted to and recorded in a personal computer, a smart device, or a server that manages the surveying instrument 2.

Next, in Step S105, when the worker continues the measurement, the processing returns to Step S102 and the worker continues the measurement by applying the measuring marker 4 to another measurement point X. When the worker ends the work, the measurement is ended.

(Effects)

As described above, according to the present embodiment, the measuring marker 4 and the surveying instrument 2 work together and a three-dimensional position of a measurement point X is automatically measured. At this time, a worker only has to carry the measuring marker 4 with him/her and irradiate the measurement point X with the laser light 5, so that the survey work can be simplified.

In addition, according to the present embodiment, the surveying instrument 2 is guided to the measurement point X according to position information and posture information of the emission port 4b of the measuring marker 4 and image processing, so that the measurement can be performed without depending on tracking of a prism.

In addition, the measuring marker 4 according to the present embodiment does not have to include large elements such as a prism and a camera, and can be formed into a pen size. Therefore, a worker can easily handle the measuring marker 4.

### 2. Second Embodiment

In a second embodiment, the measuring marker 4 includes a distance meter 48, and enables a higher-speed measurement.

2-1. Configuration of Measuring System

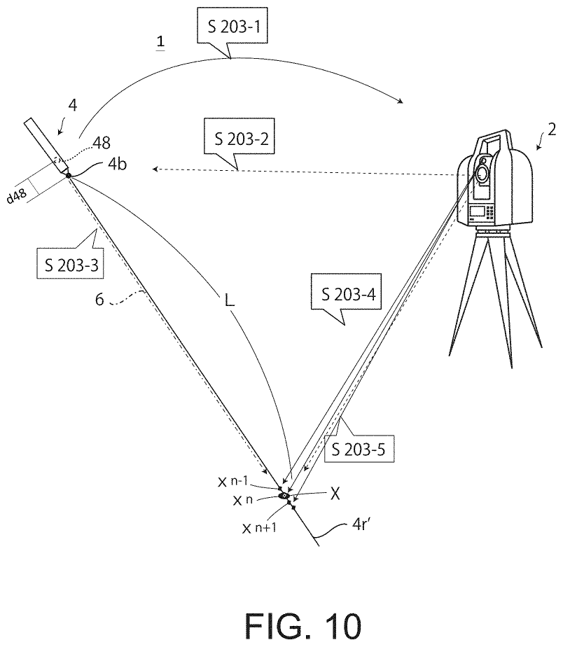

In a measuring system 1 according to the second embodiment, the configuration of the surveying instrument 2 is the same as in the first embodiment (FIG. 2). On the other hand, the measuring marker 4 includes the distance meter 48 in addition to the configuration of the first embodiment (FIG. 4) (refer to FIG. 10 described later). The distance meter 48 includes a light transmitting section and a light receiving section, and emits distance-measuring light, for example, infrared pulsed laser or the like (hereinafter, referred to as marker distance-measuring light 6 for distinction from the distance-measuring light 3 of the surveying instrument 2) from the light transmitting section, and measures a distance based on a time to light reception and light speed. The distance meter 48 is configured by using a dedicated module and IC configured by using the integrated circuit technology, and is housed compactly in the stick body 40 so that an optical axis of the marker distance-measuring light 6 matches the optical axis of the laser light 5. In addition, the distance meter 48 is disposed on the marker axial direction 4r, and a positional relationship (for example, a separating distance d48) with the emission port 4b is measured and stored in advance in the storage section 43.

2-2. Measuring Method

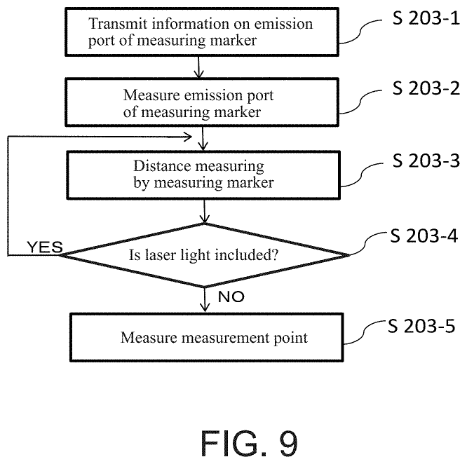

An overall flow of a three-dimensional position measuring method for a measurement point X by using the measuring system 1 in the second embodiment is the same as that in the first embodiment (FIG. 5). In the present embodiment, details of the measurement are changed. FIG. 9 is a detailed flowchart of a measurement for the three-dimensional position measuring method according to the second embodiment, and FIG. 10 is a work image view of FIG. 9.

Steps S203-1 and S203-2 are the same as in the first embodiment (Steps S103-1 and S103-2), and when the measuring button 4a2 of the measuring marker 4 is pressed, the measuring marker 4 transmits posture information and position information of the emission port 4b to the surveying instrument 2, and the surveying instrument 2 measures a three-dimensional position (three-dimensional coordinates) of the emission port 4b.

In the present embodiment, in Step S203-3, at the same time as pressing of the measuring button 4a2, the measuring marker 4 performs a distance measuring for the measurement point X by the distance meter 48 to measure a distance from the emission port 4b to the measurement point X (hereinafter, referred to as a marker distance L). The measuring marker 4 also transmits information on the marker distance L to the surveying instrument 2.

Next, in Step S203-4, based on posture information of the measuring marker 4, the surveying instrument 2 grasps the marker axial direction 4r, and searches for the measurement point X in the marker axial direction 4r, and here, in Step S203-3, the marker distance L has already been known, so that the arithmetic control section 27 estimates a position offset by the marker distance L in the marker axial direction 4r from the three-dimensional position of the emission port 4b (“estimated position” in the claims) as the measurement point X. Therefore, as the object points, an object point is set at a position where the measurement point X is estimated to be present (object point xn in FIG. 10) and, before and after this point, several object points (object points xn−1 and xn+1 in FIG. 10) are set, and for these several points, it is analyzed whether an image of the laser light 5 is included. Then, an object point right before a point where the laser light 5 disappears is determined as the measurement point X, and a non-prism distance measuring is performed for the measurement point X by the distance-measuring section 30 of the surveying instrument 2 to measure a three-dimensional position (three-dimensional coordinates) of the measurement point X.

(Effects)

As described above, according to the present embodiment, since the measuring marker 4 includes the distance meter 48, a position of a measurement point X can be roughly estimated, and the number of image analyses by the surveying instrument 2 can be significantly reduced, and therefore, the measurement can be further increased in speed.

3. Modifications

The embodiments described above are preferably modified as follows.

3-1. Modification 1

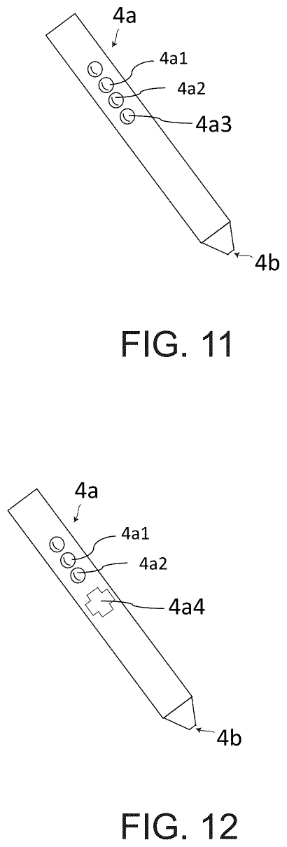

For example, it is also preferable that the measuring marker 4 is configured to variously change the laser light 5. In the measuring system 1, the measurement point X is searched for by image analysis. Therefore, it is considered that it may be difficult for the surveying instrument 2 to analyze the laser light 5 depending on a measurement environment including the background of the object point and the weather. FIG. 11 is a perspective view of a measuring marker 4 according to Modification 1. In Modification 1, the operation button group 4a of the measuring marker 4 further includes an emission change button 4a3. With the emission change button 4a3, emission of the laser light 5 can be changed to flashing emission, changed in light color, or changed in pattern shape. The laser emitting section 47 includes a light source and an emission control IC provided for these changes. According to Modification 1, emission of the laser light 5 can be changed according to a measurement environment, so that the measurement can be prevented from becoming difficult due to an image analysis failure of the surveying instrument 2.

3-2. Modification 2

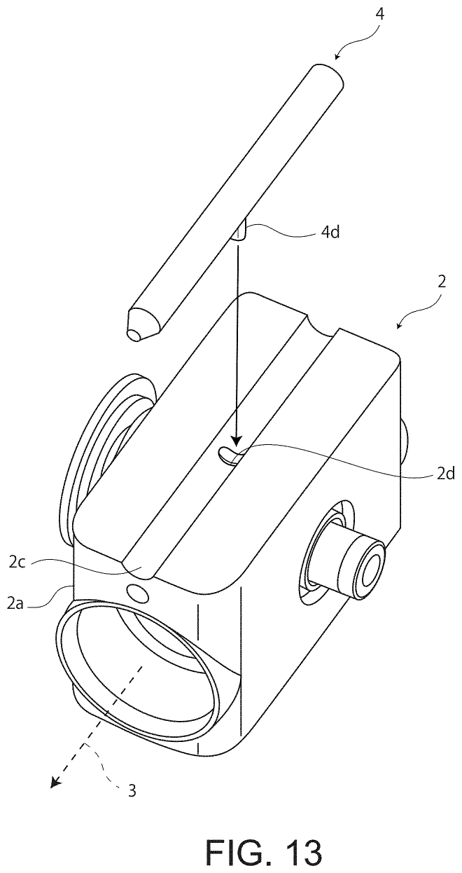

In addition, it is also preferable that the measuring marker 4 is provided with an adjusting function. FIG. 12 is a perspective view of a measuring marker 4 according to Modification 2. In Modification 2, the operation button group 4a of the measuring marker 4 further includes an adjust button 4a4. The adjust button 4a4 includes an up-down button and a left-right button, and the vertical rotation drive section 24 of the surveying instrument 2 (vertical angle of the distance-measuring section 30) can be operated with the up-down button, and the horizontal rotation drive section 23 of the surveying instrument 2 (horizontal angle of the distance-measuring section 30) can be operated with the left-right button. According to Modification 2, when a worker feels a sense of discomfort in the collimation direction of the surveying instrument 2 or wants to promptly perform searching of the measurement point X, the worker can adjust the vertical angle and the horizontal angle of the surveying instrument 2 by operating the adjust button 4a4, and roughly guide the orientation of the surveying instrument 2 to the measurement point X, and therefore, the operability in the measurement can be improved.

3-3. Modification 3

In addition, it is also preferable that the surveying instrument 2 includes a guide for synchronizing the measuring marker 4. FIG. 13 is a perspective view of a part of a measuring system 1 according to Modification 3. In the measuring system 1, before a measurement, the measuring marker 4 must be synchronized by aligning the coordinates and posture of the measuring marker 4 with the reference of the surveying instrument 2. Therefore, as an example, in Modification 3, on an upper surface of the telescope 2a of the surveying instrument 2, a guide groove 2c matching the optical axis direction of the distance-measuring light 3 is formed. The guide groove 2c has an engagement recess 2d at its center, and the measuring marker 4 also has an engagement protrusion 4d at its center. The guide groove 2c is the “guide” in the claims, and the engagement recess 2d and the engagement protrusion 4d are the “engagement portions” in the claims. By disposing the measuring marker 4 in the guide groove 2c, the posture of the measuring marker 4 can be aligned with the reference direction of the surveying instrument 2 (angle matching), and by fitting the engagement protrusion 4d into the engagement recess 2d, the coordinates of the measuring marker 4 can be matched with the coordinates of the surveying instrument 2 (position matching). According to Modification 3, synchronization of the measuring system 1 can be more easily performed. The shapes of the guide and the engagement portions are just examples, and as a matter of course, can be changed to other forms.

3-4. Others

In the embodiments, the measuring marker 4 is operated by a worker, so that when pointing out the measurement point X, irradiation of the laser light 5 may move due to hand shake. It is also preferable that when the image of the laser light 5 moves, an average position and a 2-second convergence position, etc., may be applied as a condition for analysis in the surveying instrument 2.

In the embodiments, one of the features is that tracking of a prism is not required, however, when the measurement point X is a prism, the distance-measuring section 30 of the surveying instrument 2 is allowed to perform a prism distance measuring. As described in “details of the measurement,” the measurement point X is searched for by image analysis in the imaging section 29, however, when the measurement point X is a prism, at a stage where the position of the measurement point X is roughly known, the surveying instrument 2 can perform automatic collimation to the prism.

Embodiments and modifications of the measuring system 1 have been described above, and besides these, the respective embodiments and modifications can be combined based on knowledge of a person skilled in the art, and such a combined embodiment is also included in the scope of the present invention.

### REFERENCE SIGNS LIST

1 Three-dimensional position measuring system
2 Surveying instrument
2c Guide groove (guide)
2d Engagement recess (engagement portion)
21 Horizontal angle detector (angle-measuring section)
22 Vertical angle detector (angle-measuring section)
23 Horizontal rotation drive section (drive section)
24 Vertical rotation drive section (drive section)
27 Arithmetic control section
28 Storage section
29 Imaging section
30 Distance-measuring section
31 Communication section
3 Distance-measuring light
4 Measuring marker
40 Stick body
4a Operation button group
4a3 Emission change button
4a4 Adjust button
4b Emission port
4d Engagement protrusion (engagement portion)
4r Marker axial direction (axial direction)
41 Communication section
42 Arithmetic control section
43 Storage section
44 Accelerometer (posture sensor)
45 Gyro sensor (posture sensor)
46 GPS device (position sensor)
47 Laser emitting section
48 Distance meter
5 Laser light
X Measurement point

1. A three-dimensional position measuring system comprising:
a surveying instrument including a distance-measuring section configured to perform a reflection prism distance measuring and a non-prism distance measuring by distance-measuring light, an imaging section configured to perform imaging in an optical axis direction of the distance-measuring light, an angle-measuring section configured to measure a vertical angle and a horizontal angle at which the distance-measuring section is oriented, a drive section configured to drive the vertical angle and the horizontal angle of the distance-measuring section to set angles, and a communication section; and
a measuring marker including a position sensor, a posture sensor, a laser emitting section configured to emit laser light of visible light in an axial direction, an emission port for the laser light, and a communication section, wherein
the measuring marker calculates position information and posture information of the emission port from the position sensor and the posture sensor and transmits the information to the surveying instrument, and
the surveying instrument measures a three-dimensional position of the emission port by the distance-measuring section and the angle-measuring section, grasps the axial direction based on the posture information and searches for a measurement point in the axial direction by the imaging section, and measures a three-dimensional position of the measurement point by the distance-measuring section and the angle-measuring section.

2. The three-dimensional position measuring system according to claim 1, wherein
the surveying instrument sets a plurality of object points in the axial direction, images the object points in order from the emission port side by the imaging section, analyzes whether an image of the laser light is included in the imaged images, determines an object point right before an object point where the image of the laser light disappears, as the measurement point, and measures the three-dimensional position.

3. The three-dimensional position measuring system according to claim 1, wherein
the measuring marker further includes a distance meter, and the distance meter measures a marker distance from the emission port to the measurement point and transmits the marker distance to the surveying instrument, and
based on information on the marker distance, the surveying instrument determines an estimated position offset by the marker distance in the axial direction from the three-dimensional position of the emission port as the measurement point and images the estimated position and several points before and after the estimated position in the axial direction by the imaging section, analyzes whether an image of the laser light is included in imaged images, determines an object point right before an object point where the image of the laser light disappears, as the measurement point, and measures the three-dimensional position.

4. The three-dimensional position measuring system according to claim 1, wherein
the measuring marker further includes an emission change button, and the emission change button changes emission of the laser light so that the emission of the laser light is at least changed to flashing emission, changed in light color, or changed in pattern shape.

5. The three-dimensional position measuring system according to claim 1, wherein
the measuring marker further includes an adjust button, and the adjust button adjusts the vertical angle and the horizontal angle of the distance-measuring section by operating the drive section.

6. The three-dimensional position measuring system according to claim 1, wherein
the surveying instrument includes a guide matching the optical axis direction of the distance-measuring light,
the surveying instrument and the measuring marker include mutual engagement portions, and
the surveying instrument and the measuring marker are synchronized in posture by disposing the measuring marker on the guide, and synchronized in position by engaging the engagement portions with each other.

7. A three-dimensional position measuring method including a surveying instrument and a measuring marker, comprising:
(a) a step of transmitting position information and posture information of an emission port for laser light to be emitted in an axial direction of the measuring marker to the surveying instrument;
(b) a step of emitting distance-measuring light from the surveying instrument and measuring a three-dimensional position of the emission port;
(c) a step of imaging a plurality of object points in the axial direction of the measuring marker in order from the emission port side by an imaging section of the surveying instrument, and analyzing whether an image of the laser light is included in imaged images;
(d) a step of determining an object point right before an object point where the image of the laser light disappears, as a measurement point; and
(e) a step of emitting distance-measuring light from the surveying instrument and measuring a three-dimensional position of the measurement point.

8. A measuring marker comprising:
a stick body; a position sensor; a posture sensor; a laser emitting section configured to emit laser light of visible light in an axial direction of the stick body; an emission port for the laser light; a communication section; an arithmetic control section; and a storage section, wherein
in the storage section, positional relationships of the position sensor and the posture sensor with the emission port are stored, and
the arithmetic control section corrects position information from the position sensor and posture information from the posture sensor by using the positional relationships to calculate position information and posture information of the emission port, and transmits the information from the communication section to the surveying instrument.
